(19) United States
(12) Patent Application Publication
(10) Pub. No.: US 2004/0255327 A1
(43) Pub. Date: Dec. 16, 2004

(54) Media content distribution system and method

(75) Inventor: Erik Arthur Scheelke, Cupertino, CA (US)

Correspondence Address: Thomas B. Haverstock, HAVERSTOCK & OWENS LLP, 162 North Wolfe Road, Sunnyvale, CA, 94086, US

(73) Assignee: Digital Deck, Inc.

(21) Appl. No.: 10/461,142

(22) Filed: Jun. 12, 2003

(51) Int. Cl. H04N 7/20; H04N 7/18; H04N 7/173

(52) U.S. Cl. 725/86; 725/63; 725/143; 725/146; 725/112

(57) ABSTRACT

A media content distribution system comprising a media source unit for transmitting media content, a media destination unit for receiving media content, and a media management unit for accepting inputs from the media source unit and outputting to the media destination unit. The system allows for redirecting media content directly from the media source unit to the media destination unit by an alternating path when the media management unit fails. The distribution system further includes a set of protocols and behaviors in the media source unit and the media destination unit to insure that in the case of failure by the media management unit, the media source unit and the media destination unit will become aware of the failure and redirect the media content along an alternate path to the user.

### FIELD OF THE INVENTION

The present invention relates generally to media distribution systems, and more specifically to systems for and methods of redirecting media content from a media source unit to a media destination unit when the media management unit fails.

### BACKGROUND OF THE INVENTION

There are numerous media sources which provide content on an output device, such as a televison set. There are standard broadcast sources which can be received by virtually any television tuner through an antenna connector. There are cable services which typically offer packages of preselected channels to the consumers and that require a decoder at the televison tuner or on the cable line at an external location. Cable services continuously broadcast scheduled programing through a preselected set of channels which are received through a cable connector on a televison set. A number of pay-per-view services allow customers to receive non-scheduled one time program transmissions through the cable network. Other available services include satellite programming which allow consumers to select on demand pay-per view-programs from a set of available programs.

Modern home entertainment systems have available a plurality of electronic systems for display or playback of audio and video programs. Examples includes video laser disc players, video cassette recorders, compact disc players, and similar systems. These media sources typically output onto TVs, LCD panels, computers, stereo receivers or other output devices.

Users expect delivery of these media sources and programming services anywhere at any time and expect a convenient system to select media offered from a plurality of content providers. Therefore, new technology is needed for the distribution of media content sources, so that the distribution of the sources is maintained throughout the distribution network even when certain units and protocols in the network fail.

### SUMMARY OF THE INVENTION

A method of and system for a media content distribution system is disclosed. The media content distribution system comprises a media source unit for transmitting media content and a media destination unit for receiving the media content. The distribution system further includes a media management unit for accepting inputs from the media source unit and directing the media content to the media destination unit along a first path and means for redirecting the media content from the media source unit to the media destination unit along an alternating path in case the media management unit fails.

The media content can be produced from a satellite or cable service provider. The media content can also be produced from radio, a computer, or a consumer electronic device, such as a DVD player, VCR, CD player, cassette player or laserdisc player.

The media source unit can be a transmitter unit and the media destination unit can be a receiver unit. The media management unit is a switcher or computer. The alternate path can be through another media management unit or even via a direct signal path.

The distribution system can further include an encoder means for encoding the media content from the media source unit and a decoder means for decoding the media content from the destination unit. The distribution system further includes means for keeping track in memory of the media content accepted by the media source unit and requested by the media management unit when the media management unit fails. When this occurs, the media source unit will redirect the media content to the media destination unit by an alternating path so that a user can continue viewing the media content without services of the media management unit.

When the media destination unit receives the media content, an output device coupled to the media destination unit will display the media content to a user. The output device can be a television or a computer. The output device can also be a LCD panel or a stereo receiver.

In an alternative embodiment of the present invention, a method of distributing media content is provided. The method comprises the steps of: a) transmitting media content from a media source unit to a media management unit; b) receiving the media content from the media management unit along a first path; and c) redirecting the media content from the media source unit to a media destination unit along an alternating path in case the media management unit fails.

In accordance with the embodiment of the invention, the media content can be produced from a satellite or cable service provider. The media content can also be produced from radio, a computer, or a consumer electronic device, such as a DVD player, VCR, CD player, cassette player or laserdisc player.

The media source unit can be a transmitter unit and the media destination unit can be a receiver unit. The media management unit is a switcher or computer. The alternate path can be through another media management unit or even via a direct signal path.

The method can further include an encoder means for encoding the media content from the media source unit and a decoder means for decoding the media content from the destination unit. The method further includes means for keeping track in memory of the media content accepted by the media source unit and requested by the media management unit when the media management unit fails. When this occurs, the media source unit will redirect the media content to the media destination unit by an alternating path so that a user can continue viewing the media content without services of the media management unit.

When the media destination unit receives the media content, an output device coupled to the media destination unit will display the media content to a user. The output device can be a television or a computer. The output device can also be an LCD panel or a stereo receiver.

In accordance with the embodiment of the invention, a media content distribution system comprises means for transmitting media content from a media source unit to a media management unit and means for receiving the media content from the media management unit along a first path. The distribution system further includes means for redirecting the media content from the media source unit to the media destination unit along an alternate path in case the media management unit fails.

In accordance with the preceding alternative, the media content can be produced from a satellite or cable service provider. The media content can also be produced from radio, a computer, or a consumer electronic device, such as a DVD player, VCR, CD player, cassette player or laserdisc player; and an output device is further included, which can be a television, computer, LCD panel, or stereo receiver.

### BRIEF DESCRIPTION OF THE DRAWINGS:

FIG. 1 illustrates a media distribution system in accordance with the present invention.

FIG. 2 is a block diagram illustrating a media distribution system.

FIG. 3 is a block diagram illustrating a media distribution system in accordance with the present invention.

FIG. 4 is a flow chart illustrating a method of a media distribution system in accordance with the present invention.

### DETAILED DESCRIPTION OF THE PREFERRED EMBODIMENT

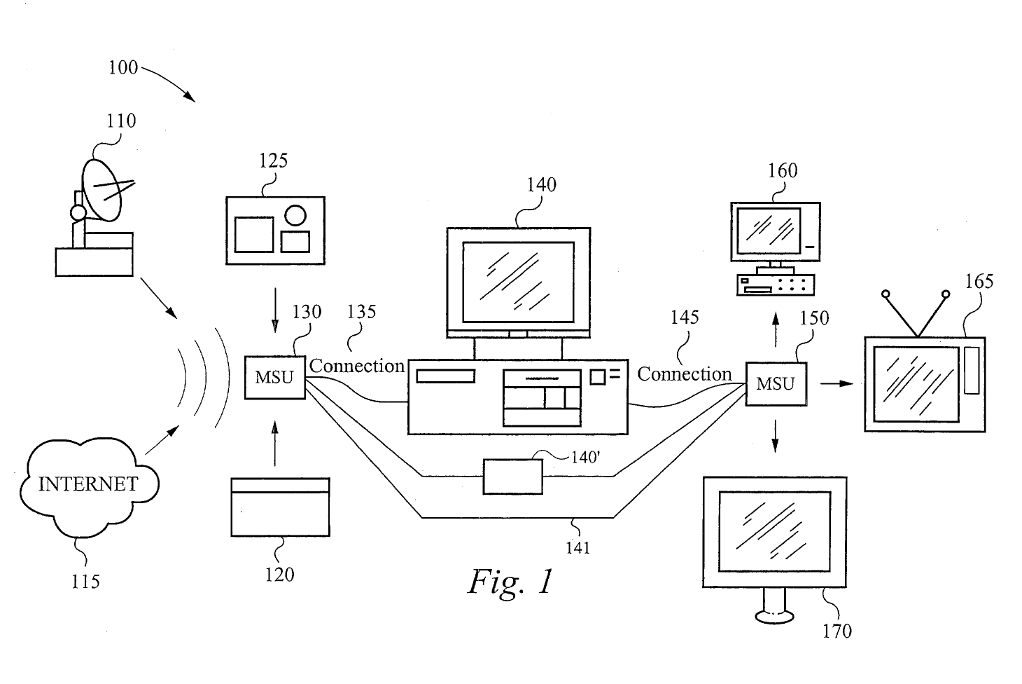

FIG. 1 illustrates a media distribution system according to the present invention. Generally, in the media distribution system, high-quality media signals, such as audio, video, and data signals, are carried, distributed, and switched through twisted pair or coaxial cables. The system includes a media source unit (MSU) 130, a media management unit (MMU) 140 which allows any of its inputs to be independently connected to any of its outputs, a media destination unit (MDU) 150, and an output device, which will display content to a user. The media source unit 130 can be a transmitter unit and the media destination unit 150 a receiver unit. The media management unit can be a computer or switcher.

Modern media distribution systems have a plethora of media sources that users can choose from. Examples include satellite 110, cable service providers 115, radio 125, and the Internet 115, in addition to electronic systems located and installed in a typical home entertainment system, such as video cassette recorders, DVD players, and CD players. In a typical installation, these media content sources are coupled to a media source unit 130. The media source unit 130 in FIG. 1 accepts a set of audio, video and/or data signals from its associated content source. The media source unit 130 typically applies an encoding mechanism to the signals and the encoded signals are then placed on a connection means 135, such as a coaxial or twisted pair cable, for transmission to the media management unit 140, which can be a computer or switcher. The media management unit 140 will accept a set of inputs from the media source unit 130 and connect the inputs to outputs corresponding to the media destination unit 150 via a connection 145. The media destination unit 150 accepts the encoded signals, decodes the signals, and provides a set of outputs to an output display, such as a computer 160, television set 165, or LCD panel 170.

In case the media management unit 140 fails to accept the media content, the media content is redirected from the media source unit 130 to the media destination unit 150 by an alternate path 140′ or 141, so that a user can continue viewing the media content. A set of protocols and behaviors in the media source unit 130 and the media destination unit 150 insures that in the case of failure by the media management unit 140, the media source unit 130 and the media destination unit 150 will become aware of failure. When this occurs, the media source unit 130 will redirect the stream of media content directly to the media destination unit 150 by an alternate path 140′ or 141 so that the user can continue viewing the media content without services of the media management unit 140. The alternate path can be through another media management unit 140′ or even via a direct signal path 141.

The media destination unit 150 preferably monitors the stream of media content to detect when it is no longer being sent out by the media management unit 140. The monitoring can include a handshake protocol between the media source unit 130 and the media management unit 140. Upon detecting a failure, the media destination unit 150 disconnects from the media management unit 140 and provides media content by an alternative path 140′ or 141. The system, therefore, includes means for keeping track in memory of the media content accepted by the media source unit 130 and requested by the media management unit 140 prior to the failure of the media management unit 140.

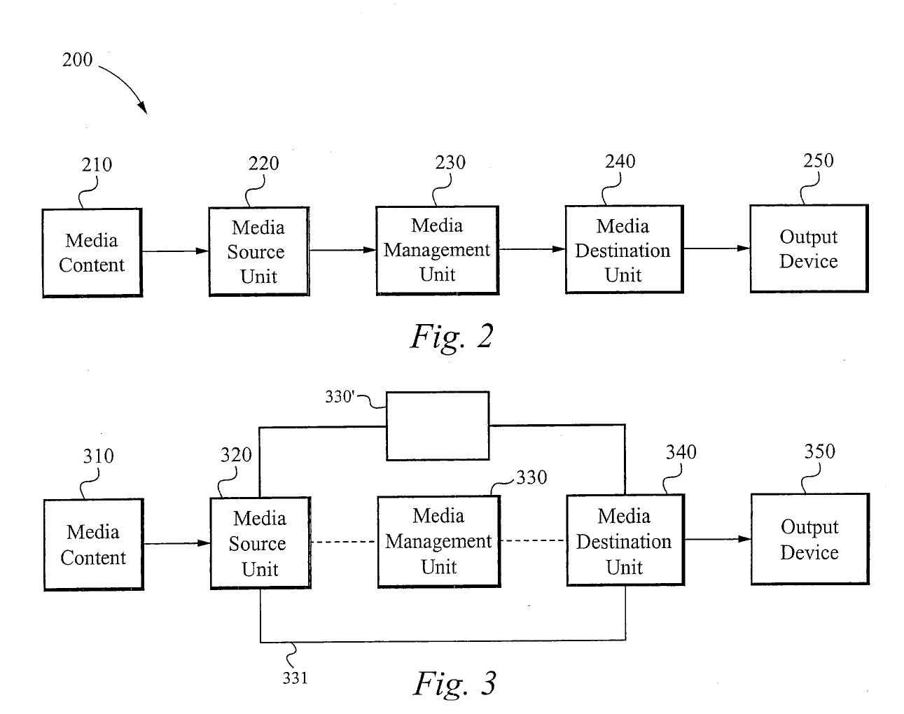

FIG. 2 is a block diagram illustrating a media distribution system 200 including a media content unit 210, a media source unit 220, a media management unit 230, and a media destination unit 240. The media source unit 220 can be a transmitter unit that accepts and then transmits media content from the media content unit 210. The media content unit 210 can be a satellite or cable service provider. Additional media content units 210 include radio, a computer, or a consumer electronic device, such as a DVD player, VCR, CD player, cassette player or laserdisc player. Regardless of the media content unit 210, the media content received by the media source unit 220 are then transmitted to a media management unit 230. The system can include an encoder means for encoding the media content 210 prior to transmission. In this manner, the signals can be transmitted either securely or without any appreciable signal degradation.

Once encoded, the signal is then transmitted to the media management unit 230. The media management unit 230 is a switcher or computer. The media management unit 230 has a set of inputs, a set of outputs, and a switching system which allows for each one of the inputs to be independently connected to any or all of the outputs. Each input can accept an encoded electronic signal from the media source unit 210. Each output from the media management unit 230 connects to the media destination unit 240. The media destination unit 240 can be a receiver unit. The function of the media destination unit 240 is to receive an encoded signal from the media management unit 230, decode the signal, and provide a set of media outputs corresponding to the decoded signals. These media outputs are then provided to an output device 250, which will then display the media content to a user. The output device 250 can be a television or a computer. The output device can also be a LCD panel or a stereo receiver or combination thereof.

FIG. 3 is a block diagram illustrating a media distribution system 300 in accordance with the present invention, which is configured to provide a continuous stream of content data even when the media management unit 330 fails.

A set of protocols and behaviors in the media source unit 320 and the media destination unit 340 insures that in the case of failure by the media management unit 330, the media source unit 320 and the media destination unit 340 will become aware of failure. When this occurs, the media source unit 320 will redirect the stream of media content to the media destination unit 340 by an alternate path so that the user can continue viewing the media content without services of the media management unit 330. The alternate path can be through another media management unit 330 or even via a direct signal path.

The media destination unit 340 preferably monitors the stream of media content to detect when it is no longer being sent out by the media management unit 330. The monitoring can include a handshake protocol between the media source unit 320 and the media management unit 330. Upon detecting a failure, the media destination unit 340 disconnects from the media management unit 330 and provides media content by an alternative path. The system, therefore, includes means for keeping track in memory of the media content accepted by the media source unit 320 and requested by the media management unit 330 prior to the failure of the media management unit 330.

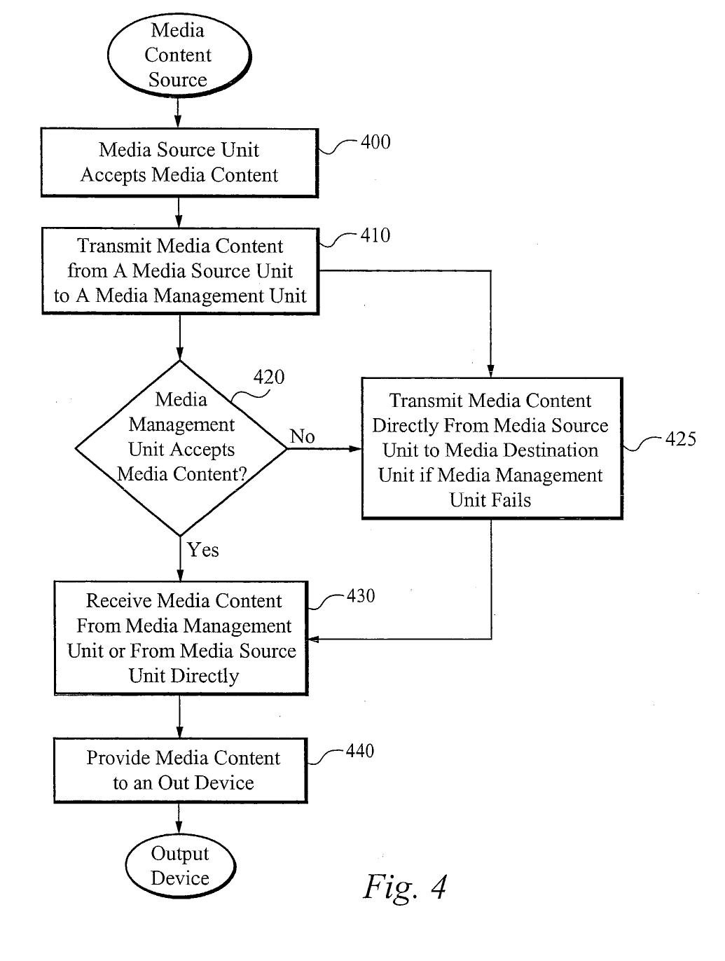

FIG. 4 is a flow chart illustrating a method of a media distribution system in accordance with the present invention. In the step 400 a media source unit accepts media content. Next, in the step 410, the media source unit transmits the media content to a media management unit. The media source unit can be a transmitter unit that accepts and then transmits media content from the media content unit. The media content unit can be a satellite or cable service provider. Additional media content units include radio, a computer, or a consumer electronic device, such as a DVD player, VCR, CD player, cassette player or laserdisc player. It does not matter what type each individual media content source may be.

The media management unit is a switcher or computer. The media management unit has a set of inputs, a set of outputs, and a switching system which allows for each one of the inputs to be independently connected to any or all of the outputs. The system can include an encoder means for encoding the media content prior to transmission. In this manner, the signals can be transmitted either securely or without any appreciable signal degradation.

Ideally, the media management unit accepts the media content from the media source unit in the step 420 and provides a set of encoded signals to the media destination unit via the step 430. The function of the media destination unit is to receive an encoded signal from the media management unit, decode the signal, and provide a set of media outputs corresponding to the decoded signals. These media outputs are then provided to an output device in the step 440, which will then display the media content to a user. The output device can be a television or a computer. The output device can also be an LCD panel or a stereo receiver.

In case the media management unit fails to accept the media content in the step 420, the media content is redirected from the media source unit to the media destination unit by an alternate path, via the step 425, so that the user can continue viewing the media content. As stated above, a set of protocols and behaviors in the media source unit and the media destination unit insures that in the case of failure by the media management unit, the media source unit and the media destination unit will become aware of failure. When this occurs, the media source unit will redirect the stream of media content directly to the media destination unit by an alternate path so that the user can continue viewing the media content without services of the media management unit. The alternate path can be through another media management unit or even via a direct signal path.

The media destination unit preferably monitors the stream of media content to detect when it is no longer being sent out by the media management unit. The monitoring can include a handshake protocol between the media source unit and the media management unit. Upon detecting a failure, the media destination unit disconnects from the media management unit and provides media content by an alternative path. The system, therefore, includes means for keeping track in memory of the media content accepted by the media source unit and requested by the media management unit prior to the failure of the media management unit.

This invention has been described in terms of specific embodiment in incorporating details to facilitate the understanding of the principles of construction and operation of the invention. Such reference herein to specific embodiment and the details thereof is not intended to limit the scope of the claims and hereto. It will be apparent to those of ordinary skill in the art that modifications can be made in the embodiment chosen for illustration without departing from the spirit and scope of the invention. Specifically, it will be apparent to one of ordinary skill in the art device of the present invention could be implemented in several different ways and the apparatus disclosed above is only illustrative of the before embodiment invention and is in no way limitation.

What is claimed is:

1. A media content distribution system comprising:
a) a media source unit for transmitting media content;
b) a media destination unit for receiving the media content;
c) a media management unit for accepting inputs from the media source unit and directing the media content to the media destination unit along a first path; and
d) means for redirecting the media content from the media source unit to the media destination unit along an alternate path in case the media management unit fails.

2. The system of claim 1, wherein the media content is produced from a satellite or cable service provider.

3. The system of claim 1, wherein the media content is produced from radio.

4. The system of claim 1, wherein the media content is produced from a computer.

5. The system of claim 1, wherein the media content is produced from a consumer electronic device, such as a DVD player, VCR, CD player, cassette player or laserdisc player.

6. The system of claim 1, wherein the media source unit is a transmitter unit.

7. The system of claim 1, wherein the media destination unit is a receiver unit.

8. The system of claim 1, wherein the media management unit is a switcher or computer.

9. The system of claim 1, further including an encoder means for encoding the media content from the media source unit.

10. The system of claim 1, further including a decoder means for decoding the media content from the media destination unit.

11. The system of claim 1, further including means for keeping track in memory the media source unit requested in response to when the media management unit fails.

12. The system of claim 1, further including an output device coupled to the media destination unit.

13. The system of claim 12, wherein the output device is a television or LCD panel.

14. The system of claim 12, wherein the output device is a computer or stereo receiver.

15. The system of claim 1, wherein the alternate path is a back-up media management unit.

16. The system of claim 1, wherein the alternate path is a direct signal path.

17. A method of distributing media content, comprising the steps of:
a) transmitting media content from a media source unit to a media management unit;
b) receiving the media content from the media management unit along a first path; and
c) redirecting the media content from the media source unit to a media destination unit along an alternate path in case tie media management unit fails.

18. The method of claim 17, wherein the media content is produced from a satellite or cable set top box.

19. The method of claim 17, wherein the media content is produced from radio.

20. The method of claim 17, wherein the media content is produced from a computer.

21. The method of claim 17, wherein the media content is produced from a consumer electronic device, such as a DVD player, VCR, CD player, cassette player or laserdisc player.

22. The method of claim 17, wherein the media source unit is a transmitter unit.

23. The method of claim 17, wherein the media destination unit is a receiver unit.

24. The method of claim 17, wherein the media management unit is a switcher or computer.

25. The method of claim 17, further including an encoder means for encoding the media content from the media source unit.

26. The method of claim 17, further including a decoder means for decoding the media content from the media destination unit.

27. The method of claim 17, further including means for keeping track in memory the media source unit requested in response to when the media management unit fails.

28. The method of claim 17, wherein the media destination unit outputs the media content to an output device.

29. The method of claim 28, wherein the output device is a television or LCD panel.

30. The method of claim 28, wherein the output device is a computer or stereo receiver.

31. The method of claim 17, wherein the alternate path is a back-up media management unit.

32. The method of claim 17, wherein the alternate path is a direct signal path.

33. A media content distribution system comprising:
a) means for transmitting media content from a media source unit to a media management unit;
b) means for receiving the media content from the media management unit along a first path; and
c) means for redirecting the media content from the media source unit to the media destination unit along an alternate path in case the media management unit fails.

34. The system of claim 33, wherein the media content is produced from a satellite or cable set top box.

35. The system of claim 33, wherein the media content is produced from radio.

36. The system of claim 33, wherein the media content is produced from a computer.

37. The system of claim 33, wherein the media content is produced from a consumer electronic device, such as a DVD player, VCR, CD player, cassette player or laserdisc player.

38. The system of claim 33, wherein the media source unit is a transmitter unit.

39. The system of claim 33, wherein the media destination unit is a receiver unit.

40. The system of claim 33, wherein the media management unit is a switcher or computer.

41. The system of claim 33, further including an encoder means for encoding the media content from the media source unit.

42. The system of claim 33, further including a decoder means for decoding the media content from the media destination unit.

43. The system of claim 33, further including means for keeping track in memory the media source unit requested in response to when the media management unit fails.

44. The system of claim 33, further including an output device coupled to the media destination unit.

45. The system of claim 44, wherein the output device is a television or LCD panel.

46. The system of claim 44, wherein the output device is a computer or stereo receiver.

47. The system of claim 33, wherein the alternate path is a back-up media management unit.

48. The system of claim 33, wherein the alternate path is a direct signal path.
